(19) United States
(12) Patent Application Publication
(10) Pub. No.: US 2011/0067547 A1
(43) Pub. Date: Mar. 24, 2011

(54) SINGING CAKE KIT SYSTEMS

(76) Inventor: Willie Willis, Lakeland, FL (US)

(21) Appl. No.: 12/871,799

(22) Filed: Aug. 30, 2010

Related U.S. Application Data
(60) Provisional application No. 61/244,061, filed on Sep. 20, 2009.

(51) Int. Cl. G10F 1/06

(52) U.S. Cl. 84/94.2

(57) ABSTRACT

A musical recording and playback device is disclosed herein comprising: a flexible plastic bag enclosure serving as a isolator; an electronic integrated circuit for storing a pre-programmed recorded message; at least one speaker for audibly emitting the pre-programmed recorded message to at least one honored recipient; a portable DC power source; a start button acting as an on/off switch for turning the device on to play a message and/or song. The flexible enclosure isolatably contains the generally planar electronic integrated circuit, the speaker, and the portable DC power source assembly. The musical recording and playback device is associated with a festive cake comestible. A kit for use with the cake and method of use is also disclosed herein.

### CROSS-REFERENCE TO RELATED APPLICATION

The present application is related to and claims priority from prior provisional application Ser. No. 61/244,061, filed Sep. 20, 2009 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

1. Field of the Invention

The present invention relates generally to the field of musical devices and more specifically relates to a singing cake kit.

2. Description of the Related Art

Cake is a comestible, typically a sweet, baked dessert. Cakes normally contain some combination of flour, sugar, eggs, and butter or oil, with some varieties also requiring liquid (milk or water) and leavening agents such as yeast or baking powder. Cakes are often decorated and may be used when celebrating various momentous occasions, such as birthdays, weddings and anniversaries. Many cakes are decorated according to the theme of a party. For example a birthday cake may have a layer of white icing with the name of the person celebrating the birthday written in a different color on top of the white icing and an appropriate number of candles signifying the celebrated years of life the person has reached. Traditionally, persons gather around the celebrated individual and sing Happy Birthday. A need exists for a variable themed pre-recorded message and personalized music to play from a cake which may assist individuals in turning any event or occasion into a memorable affair.

Various attempts have been made to solve the above-mentioned problems such as those found in U.S. Pat. Nos. 5,063,698; 3,798,806; 3,462,157; 4,801,478; 4,947,722 2006/0153344; and 5,736,659. This prior art is representative of audible music playing devices. None of the above inventions and patents, taken either singly or in combination, is seen to describe the invention as claimed.

Ideally, a singing cake kit should provide a personal themed audible message and/or musical which operates reliably and be manufactured at a modest expense. Thus, a need exists for a reliable singing cake kit system to serve the above-mentioned purposes and avoid the above-mentioned problems.

### BRIEF SUMMARY OF THE INVENTION

In view of the foregoing disadvantages inherent in the known musical devices art, the present invention provides a novel singing cake kit system. The general purpose of the present invention, which will be described subsequently in greater detail is to provide a singing cake kit that reliably audibizes a themed message to memorialize a special occasion.

A musical recording and playback device is disclosed herein comprising: a flexible enclosure serving as a isolator; an electronic integrated circuit for storing a pre-programmed recorded message; at least one speaker for audibly emitting the pre-programmed recorded message to at least one honored recipient; a portable DC power source; a start button acting as an on/off switch for turning the device on to play a message and/or song. The flexible enclosure isolatably preferably contains the electronic integrated circuit, the speaker, and the portable DC power source. The musical recording and playback device is associated with a festive comestible.

The start button may be remotely in communication with the electronic integrated circuit via extension wires or wireless communication means. The flexible enclosure within the present invention preferably comprises a plastic bag (such as those made by Ziploc®), the flexible enclosure comprising re-sealable means via a zipper. The pre-programmed recorded message used in this novel device comprises a theme song such as a birthday song (Happy Birthday or other); a wedding song; a romantic themed song such as a Valentines song or a sports-related song for games such as football, hockey, national anthems, etc. The theme song may comprise a secular or religious holiday song for occasions such as Christmas, Easter, New Years, Halloween or other. The musical recording and playback device is designed for use mainly with festive comestible such as cake. The flexible enclosure serving as an isolator; the electronic integrated circuit; the speaker; and the portable DC power source form a planar assembly suitable for minimal-disturbance-placement under the cake making the device simple, cost-effective and reliable to use.

Next, a kit is described for the musical recording and playback device comprising: a flexible enclosure serving as an isolator; an electronic integrated circuit for storing a pre-programmed recorded message; at least one speaker for audibly emitting the pre-programmed recorded message to at least one honored recipient; and a portable DC power source (a battery or other). The flexible enclosure isolatably contains the electronic integrated circuit, the speaker, and the portable DC power source when the present inventive device is associated with a festive comestible (cake or other). The kit may also include instructions for use for example for recording instructions or to play other songs. The device is preferably re-usable.

Lastly, a method of using a musical recording and playback device assembly in combination with a festive comestible is described herein comprising the steps of: including an isolated kit for a musical recording and playback device assembly under a cake; remotely starting an electronic sound recording embodying a themed personalized audible message via a start button; and playing the themed personalized audible message for at least one honored recipient. The method may also further comprise the optional first step of recording the themed personalized audible message for the honored recipient(s) to communicate at least one greeting.

The present invention holds significant improvements and serves as a singing cake kit system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, singing cake kit system, constructed and operative according to the teachings of the present invention.

FIG. 1 shows a perspective view illustrating a singing cake kit system according to an embodiment of the present invention.

FIG. 2 is a perspective view illustrating a flexible enclosure as used to protect the singing cake kit system according to an embodiment of the present invention of FIG. 1.

FIG. 3 is a perspective view illustrating the singing cake kit system in use according to an embodiment of the present invention of FIG. 1.

FIG. 4 is a flowchart illustrating a method of using the singing cake kit system according to an embodiment of the present invention of FIGS. 1-3.

The various embodiments of the present invention will hereinafter be described in conjunction with the appended drawings, wherein like designations denote like elements.

### DETAILED DESCRIPTION

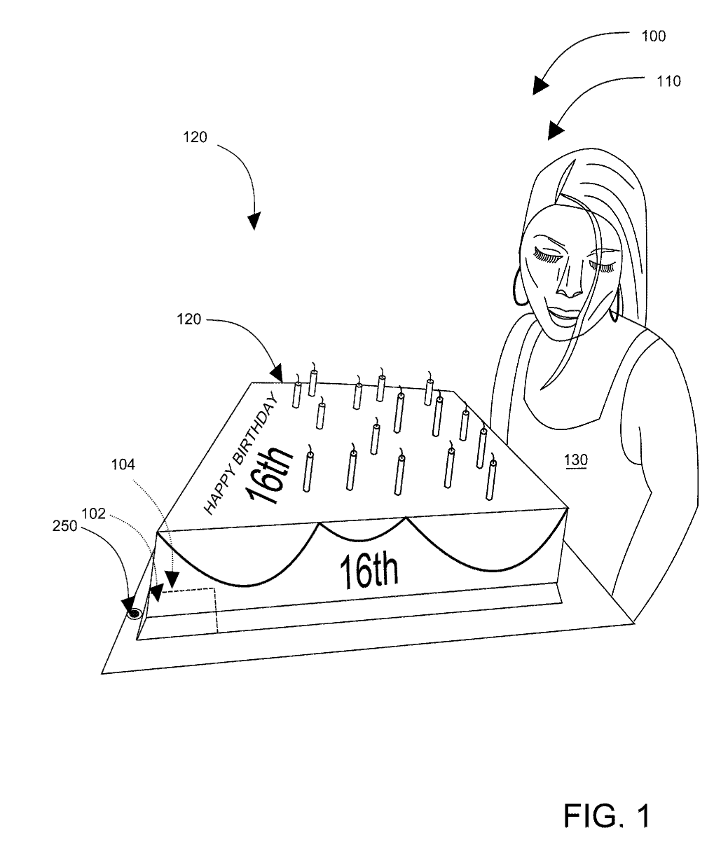

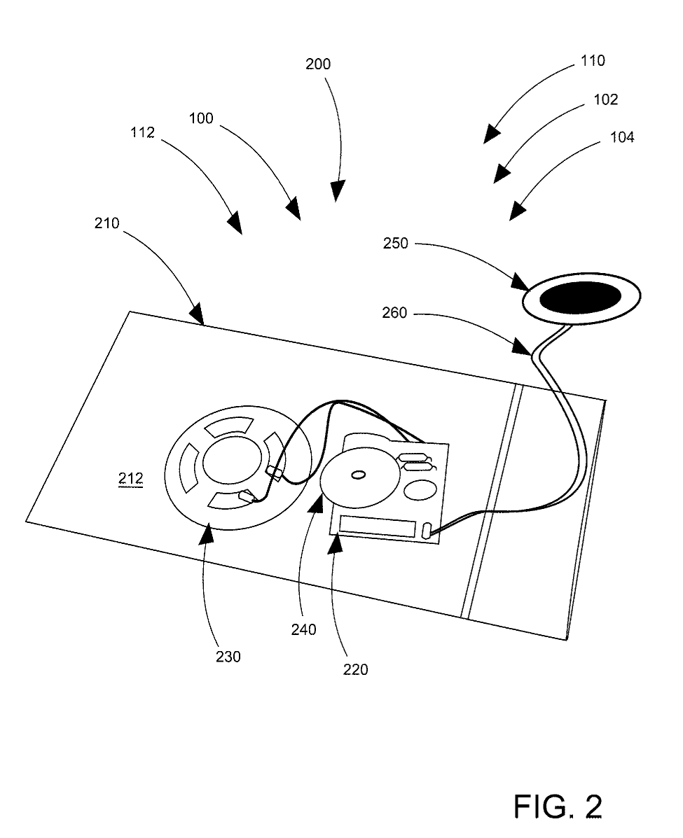

As discussed above, embodiments of the present invention relate to an electronic musical device and more particularly to a singing cake kit, as used to audibly deliver a personalized message and promote a fun theme at a momentous event. Referring to the drawings by numerals of reference there is shown in FIG. 1, a perspective view illustrating singing cake kit system 100 according to an embodiment of the present invention. Singing cake kit 110 provides consumers with a simple way to add sound to at least one cake 120 to add to the atmosphere of virtually any momentous occasion. This unique product can assist individuals in adding a novel and entertaining touch to a standard cake 120 to further make the occasion special and memorable. This innovative item is ideal for use at birthdays, football parties, weddings, baby and bridal showers and other times a cake 120 may be served to celebrate an event. Singing cake kit system 100, as shown in FIG. 2, may be marketed as an off-the-shelf sound card (electronic integrated circuit 220), mounted in a flexible enclosure 210 or vacuumed pack and/or in a sealed utility plastic bag 212 and/or in certain embodiments mounted on the base of a cake plate. Start button 250, may be a pluggable external device. This external unit will be available in different themes, like a small teddy bear, a heart shaped pillow, a gag theme, or other such design.

In an embodiment of the present invention to coordinate use of singing cake kit 110 the user places cake 120 on the cake plate, then plugs up the theme selection unit, and have sound coming from the cake by pressing start button 250. Theme selection unit may comprise a single song or greeting or a plurality of songs and/or greetings, or combination thereof. In another embodiment, to use one of the sealed packaged options of singing cake kit system 100, a user may slide the device under the bottom of cake 120 or between the layers, plug up the external theme selection unit and have sound when start button 250 is pressed. In this way singing cake kit 110 offers users a simple way to have a specific song or recorded message play from within or underneath cake 120. This product may be an electronic soundcard to play music or a prerecorded personalized message. The electronic soundcard may be a thin, printed circuit board assembly (electronic integrated circuit 220) with at least one battery (DC power source 240) and at least one speaker 230.

In certain embodiments singing cake kit system 100 may have the ability to store a predetermined song or message. Singing cake kit system 100 may also have a recording mode to create a personalized message, and a push button or a light change sensor wired to the PCB assembly via approximately 3″ wires (or other suitable length as required). The electronic PCB assembly may be placed in a utility zip-locking bag (flexible enclosure 210 and/or plastic bag 212) with the external start unit (start button 250) placed outside plastic bag 212. This unit may be placed in or under cake 120 to create music for assorted occasions. Singing cake kit system 100 comprises musical recording and playback device 102. Singing cake kit system 100, as described above comprises flexible enclosure 210 (in this particular embodiment, plastic bag 212—which comprises zippably sealable means serving as an isolator); electronic integrated circuit 220; at least one speaker 230; and portable DC power source 240 form planar assembly 200 suitable for minimal-disturbance-placement under cake 120.

Predetermined songs within singing cake kit system 100 may vary according to user-preference. The music or message may be accessed by pressing start button 250 or a motion sensor placed outside of the bottom layer of cake 120. The exact dimensions, materials used for construction and method of operation of singing cake kit 110 may vary upon manufacturing.

Referring now to FIG. 2, a perspective view illustrating flexible enclosure 210 as used to protect singing cake kit system 100 according to an embodiment of the present invention of FIG. 1.

As aforementioned in FIG. 1 singing cake kit system 100 comprises musical recording and playback device 102, musical recording and playback device 102 comprising: flexible enclosure 210 serving substantially as a isolator (isolation means from cake 120 and ambient environment to protect from moisture-rich environment, corrosion and static electricity); at least one electronic integrated circuit 220 for storing at least one pre-programmed recorded message; at least one speaker 230 for audibly emitting the pre-programmed recorded message(s)/greetings, songs, audibilized tones to at least one honored recipient 130; and a portable DC power source 240.

Flexible enclosure 210 isolatably contains electronic integrated circuit 220, speaker(s) 230, and portable DC power source 240 and musical recording and playback device 102 is associated with a festive comestible, preferably cake 120, however it should be appreciated that the scope of the invention includes other comestibles and that cake 120 is merely exemplary. In this particular embodiment festive comestible comprises cake 120. Those with ordinary skill in the art will now appreciate that upon reading this specification and by their understanding the art of electronic audibilizing, recording, inputting, communicating, outputting, and powering means as described herein, methods of providing these portable audibilized messages and/or songs electronically singly or in combination will be understood by those knowledgeable in such art.

Musical recording and playback device 102 in certain embodiments may further comprise start button 250 acting as an on/off switch. Start button 250 is remotely in communication with electronic integrated circuit 220 via extension wires 260 or optionally wireless communication means.

Referring now to the isolation means for substantially ensuring integrity of singing cake kit system 100, flexible enclosure 210 comprises plastic bag 212 comprising resealable means via a zipper, as shown. Flexible enclosure 210 within this particular embodiment comprises reusable, re-sealable zipper storage bags containers (known as Ziploc®) and originally developed by Dow Chemical Company, and now produced by S. C. Johnson & Son. Ziploc storage and freezer bags may be made from polyethylene plastic resin, the most commercially used polymer that is available in a large range of flexibilities and densities, allowing Ziploc bags to safely hold and store various amounts and densities of foods/comestibles and other such items including those aforementioned. Upon reading this specification, it should be appreciated that, under appropriate circumstances, considering such issues as user preferences, design preference, structural requirements, marketing preferences, cost, available materials, technological advances, etc., other isolation means and arrangements such as, for example, other flexible enclosures, bags made from different materials, those bags with or without zipping means, etc., may be sufficient.

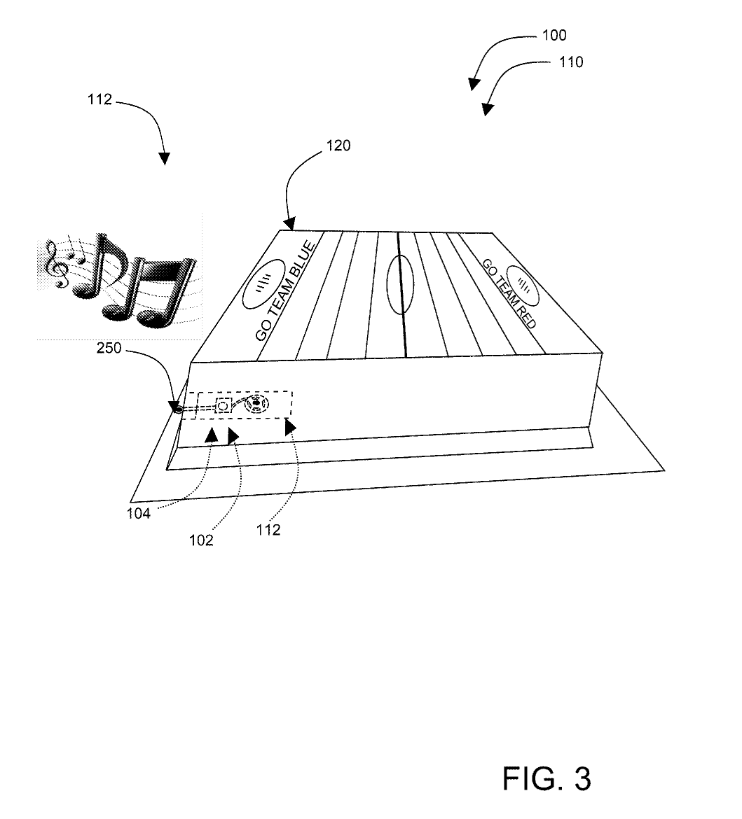

Referring now to FIG. 3, showing a perspective view illustrating singing cake kit system 100 in use according to an embodiment of the present invention of FIG. 1.

Musical recording and playback device 102 comprises at least one pre-programmed recorded message preferably comprising at least one theme song such as a birthday song; and/or a wedding song; and/or a romantic song such as a Valentines song; a sports-related song; a secular or religious song. Upon reading this specification, it should be appreciated that, under appropriate circumstances, considering such issues as user preferences, design preference, structural requirements, marketing preferences, cost, available materials, technological advances, etc., other songs, messages, playing arrangements such as, for example, songs played with or without words, different combinations of songs, messages, noises, etc., may be sufficient.

A kit 112, singing cake kit 110 for musical recording and playback device 102 may comprise: flexible enclosure 210 serving as a isolator (as discussed above); electronic integrated circuit 220 for storing a pre-programmed recorded message; speaker(s) 230 for audibly emitting at least one pre-programmed recorded message to at least one honored recipient 130 (such as a birthday boy or girl or other); and portable DC power source 240, wherein flexible 210 enclosure isolatably contains electronic integrated circuit 220, speaker 230, and portable DC power source 240 and musical recording and playback device 102 is associated with a festive comestible. Kit 112 may further comprise a pre-packaged festive comestible and instructions for use/installation.

Kit 112 preferably comprises a vacuumed pack package and the user attaches it to a cake base plate or slides it under or between the layers of cake 120. Kit 112 may further include start button 250, one of the methods of starting the present invention may be to use a motion sensor in addition to a press button. Again the start unit (start button 250 or motion sensor) will be an external unit preferably remotely connected via extension wires 260 and a plug connector. This plug connector will allow a person to select their start unit to fit their party theme. Kit 112 of singing cake kit system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, candles, parts may be sold separately, etc., may be sufficient.

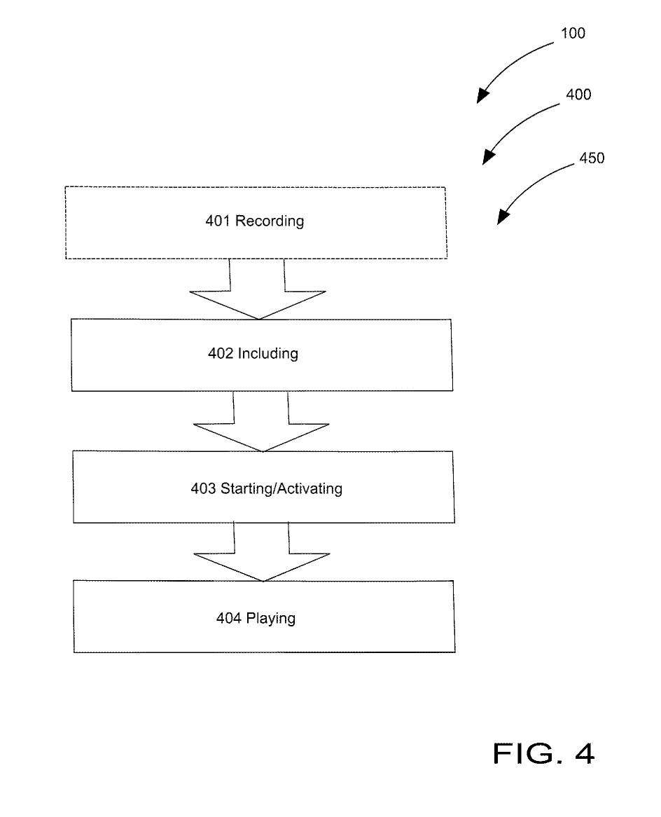

Referring now to FIG. 4, is a flowchart 450 illustrating a method of use 400 for using singing cake kit system 100 according to an embodiment of the present invention of FIGS. 1-3.

Method of use 400 for using musical recording and playback device assembly 104 in combination with a festive comestible may comprise the steps of: optionally step one 401 recording the themed personalized audible message for at least one honored recipient 130 to communicate at least one greeting; step two 402 including an isolated kit 112 for a musical recording and playback device assembly 102 under a cake 120; step three 403 remotely starting/activating an electronic sound recording embodying a themed personalized audible message via start button 250; and step four 404 playing the themed personalized audible message for at least one honored recipient 130.

It should be noted that step 401 is an optional step and may not be implemented in all cases. Optional steps of method 400 are illustrated using dotted lines in FIG. 4 so as to distinguish them from the other steps of method 400.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A musical recording and playback device comprising:
a flexible enclosure serving as a isolator;
an electronic integrated circuit for storing a pre-programmed recorded message;
at least one speaker for audibly emitting said pre-programmed recorded message to at least one honored recipient; and
a portable DC power source;
wherein said flexible enclosure isolatably contains said electronic integrated circuit, said at least one speaker, and said portable DC power source and said musical recording and playback device is associated with a festive comestible.

2. The musical recording and playback device of claim 1 further comprising a start button acting as an on/off switch.

3. The musical recording and playback device of claim 2 wherein said start button is remotely in communication with said electronic integrated circuit.

4. The musical recording and playback device of claim 3 wherein said start button is remotely in communication with said electronic integrated circuit via extension wires.

5. The musical recording and playback device of claim 3 wherein said start button is remotely in communication with said electronic integrated circuit via wireless communication means.

6. The musical recording and playback device of claim 1 wherein said flexible enclosure comprises a plastic bag.

7. The musical recording and playback device of claim 6 wherein said flexible enclosure comprises re-sealable means.

8. The musical recording and playback device of claim 7 wherein said flexible enclosure comprises a zipper.

9. The musical recording and playback device of claim 1 wherein said pre-programmed recorded message comprises a theme song.

10. The musical recording and playback device of claim 9 wherein said themed song comprises a birthday song.

11. The musical recording and playback device of claim 9 wherein said themed song comprises a wedding song.

12. The musical recording and playback device of claim 9 wherein said themed song comprises a Valentines song.

13. The musical recording and playback device of claim 9 wherein said themed song comprises a sports-related song.

14. The musical recording and playback device of claim 9 wherein said themed song comprises a religious song.

15. The musical recording and playback device of claim 1 wherein said festive comestible comprises a cake.

16. The musical recording and playback device of claim 15 wherein said flexible enclosure serving as an isolator; said electronic integrated circuit; said at least one speaker; and said portable DC power source form a planar assembly suitable for minimal-disturbance-placement under said cake.

17. A kit for a musical recording and playback device comprising:
a flexible enclosure serving as a isolator;
an electronic integrated circuit for storing a pre-programmed recorded message;
at least one speaker for audibly emitting said pre-programmed recorded message to at least one honored recipient; and
a portable DC power source;
a start button;
wherein said flexible enclosure isolatably contains said electronic integrated circuit, said at least one speaker, and said portable DC power source and said musical recording and playback device is associated with a festive comestible and started by said start button.

18. The kit for a musical recording and playback device further comprising a pre-packaged festive comestible and instructions for use.

19. A method of using a musical recording and playback device assembly in combination with a festive comestible comprising the steps of:
including an isolated kit for a musical recording and playback device assembly under a cake;
remotely starting an electronic sound recording embodying a themed personalized audible message via a start button; and
playing said themed personalized audible message for at least one honored recipient.

20. The method of using a musical recording and playback device assembly in combination with a festive comestible further comprising the step of recording said themed personalized audible message for said at least one honored recipient to communicate at least one greeting.
